(19) United States
(12) Patent Application Publication
(10) Pub. No.: US 2008/0236958 A1
(43) Pub. Date: Oct. 2, 2008

(54) Pressure vessel for vehicular air brake system

(75) Inventor: Attilio DeBiasi, Bolton (CA)

Correspondence Address: Charles N.J. Ruggiero;Ohlandt, Greeley, Ruggiero & Perle, L.L.P., 10th Floor, One Landmark Square, Stamford, CT, 06901-2682, US

(73) Assignee: DeBiasi International Limited

(21) Appl. No.: 11/729,626

(22) Filed: Mar. 29, 2007

(51) Int. Cl. B60T 1/06

(52) U.S. Cl. 188/17; 220/562

(57) ABSTRACT

There is provided a vehicular air brake system, comprising: a vehicle, a wheel rotatably coupled to the vehicle, an air brake configured for engaging the wheel to effect braking of the wheel, a pressure vessel configured for containing pressurized air, wherein the pressure vessel is fluidly coupled to the air brake and is configured to supply pressurized air to the air brake to bias the air brake to a position wherein the air brake is disengaged from the wheel, and a brake actuator coupled to the brake and configured to apply a force to the air brake to effect engagement of the air brake to the wheel in response to an application of force to the brake actuator. The pressure vessel includes a first shell portion comprising: a vessel wall portion, and a boss protruding from the vessel wall portion, wherein the boss includes a boss threaded section for receiving a fitting with a fitting threaded section, and wherein the fitting threaded section is configured to register with the boss threaded section, and wherein the boss is formed from a blank used to manufacture the first shell portion.

### FIELD OF INVENTION

This invention relates to vehicular air brake systems and, in particular, pressurized vessels used in vehicular air brake systems.

### BACKGROUND

Pressure vessels for containing and supplying air for vehicular air brake systems include welded bushing for effecting connection to flexible hoses, pressure relief devices, etc. Providing welded bushings is relatively expensive and may compromise leak integrity of the pressure vessel.

Further, bushings which are welded to such pressurized vessels are internally threaded with a tapered thread, for effecting coupling to a desired fitting having a corresponding external thread which registers with the bushing's internal thread. Depending on how the fitting is installed in the bushing, the fitting may not necessarily be desirably positioned once coupled to the bushing. Further, also depending on how the fitting is installed, the intended creation of a desired seal upon threading the fitting to the bushing may not materialize, thereby further compromising the leak integrity of the pressure vessel

### SUMMARY OF THE INVENTION

In one aspect, there is provided a pressure vessel for defining a pressure boundary between a higher pressure side and a lower pressure side, wherein the pressure vessel includes a first shell portion comprising: a vessel wall portion, and a boss protruding from the vessel wall portion. The boss includes a boss threaded section defined by straight pipe threads for receiving a fitting with a fitting threaded section. The fitting threaded section is configured to register with the boss threaded section.

In another aspect, there is provided a pressure vessel for defining a pressure boundary between a higher pressure side and a lower pressure side, wherein the pressure vessel includes a first shell portion comprising: a vessel wall portion including a first side surface and an opposite second side surface, and a boss protruding from one of the first and second side surfaces, wherein the boss includes a bore including a boss threaded section for receiving a fitting with a fitting threaded section configured to register with the boss threaded section, and wherein the boss is configured to effect fluid communication between an interior of the pressure vessel and the fitting when the fitting is received within the boss. The other one of the first and second side surfaces includes a substantially flat portion extending from a respective aperture of the other one of the first and second side surfaces and substantially within a plane having a normal axis which is substantially parallel to the axis of the respective aperture of the other one of the first and second side surfaces and 360° about an axis of the respective aperture. Also, the one of the first and second side surfaces includes a substantially flat portion extending from the boss and also extending 360° about the bore of the boss and disposed in a plane which is parallel to the plane within which the other one of the first and second side surfaces is disposed.

In a further aspect, there is provided a vehicular air brake system, comprising: a vehicle, a wheel rotatably coupled to the vehicle, an air brake configured for engaging the wheel to effect braking of the wheel, a pressure vessel configured for containing pressurized air, wherein the pressure vessel is fluidly coupled to the air brake and is configured to supply pressurized air to the air brake to bias the air brake to a position wherein the air brake is disengaged from the wheel, and a brake actuator coupled to the brake and configured to apply a force to the air brake to effect engagement of the air brake to the wheel in response to an application of force to the brake actuator. The pressure vessel includes a first shell portion comprising a vessel wall portion, and a boss protruding from the vessel wall portion, wherein the boss includes a boss threaded section defined by straight pipe threads for receiving a fitting with a fitting threaded section, and wherein the fitting threaded section is configured to register with the boss threaded section.

In yet a further aspect, there is provided a vehicular air brake system, comprising: a vehicle, a wheel rotatably coupled to the vehicle, an air brake configured for engaging the wheel to effect braking of the wheel, a pressure vessel configured for containing pressurized air, wherein the pressure vessel is fluidly coupled to the air brake and is configured to supply pressurized air to the air brake to bias the air brake to a position wherein the air brake is disengaged from the wheel, and a brake actuator coupled to the brake and configured to apply a force to the air brake to effect engagement of the air brake to the wheel in response to an application of force to the brake actuator. The pressure vessel includes a first shell portion comprising: a vessel wall portion including a first side surface and an opposite second side surface, and a boss protruding from one of the first and second side surfaces, wherein the boss includes a boss threaded section for receiving a fitting with a fitting threaded section configured to register with the boss threaded section, and wherein the boss includes a fluid passage configured to effect fluid communication between an interior of the pressure vessel and the fitting received within the boss. The other one of the first and second side surfaces includes a substantially flat portion extending from the respective aperture of the other one of the first and second side surfaces and substantially within a plane having a normal axis which is substantially parallel to the axis of the respective aperture of the other one of the first and second side surfaces and also extending 360° about an axis of the respective aperture. Also, the one of the first and second side surfaces includes a substantially flat portion extending from the boss and also extending 360° about the bore of the boss and disposed in a plane which is parallel to the plane within which the other one of the first and second side surfaces is disposed.

In yet a further aspect, there is provided a vehicular air brake system, comprising: a vehicle, a wheel rotatably coupled to the vehicle, an air brake configured for engaging the wheel to effect braking of the wheel, a pressure vessel configured for containing pressurized air, wherein the pressure vessel is fluidly coupled to the air brake and is configured to supply pressurized air to the air brake to bias the air brake to a position wherein the air brake is disengaged from the wheel, and a brake actuator coupled to the brake and configured to apply a force to the air brake to effect engagement of the air brake to the wheel in response to an application of force to the brake actuator. The pressure vessel includes a first shell portion comprising: a vessel wall portion, and a boss protruding from the vessel wall portion, wherein the boss includes a boss threaded section for receiving a fitting with a fitting threaded section, and wherein the fitting threaded section is configured to register with the boss threaded section, and wherein the boss is formed from a blank used to manufacture the first shell portion.

### BRIEF DESCRIPTION OF DRAWINGS

The method and apparatus of the preferred embodiments of the invention will now be described with the following accompanying drawings:

FIG. 1 is a schematic illustration, partly in section, of a vehicle including an embodiment of a vehicular brake system having a pressurized vessel;

FIG. 2 is a perspective view of an embodiment of a pressure vessel of a vehicular brake system;

FIG. 2A is an enlarged view of Detail “A” in FIG. 2, with four of the five fittings removed for clarity;

FIG. 3 is a side elevation view of one end portion of the pressure vessel illustrated in FIG. 2, with the fittings removed for clarity;

FIG. 3A is a sectional side elevation view of the one end portion of the pressure vessel illustrated in FIG. 3, taken along lines B-B in FIG. 3;

FIG. 3B is an enlarged view of Detail “C” in FIG. 3A;

FIG. 4 is a perspective view of another embodiment of a pressure vessel of a vehicular brake system;

FIG. 4A is an enlarged view of Detail “E” in FIG. 4, with four of the five fittings removed for clarity;

FIG. 5 is a side elevation view of one end portion of the pressure vessel illustrated in FIG. 4, with the fittings removed for clarity;

FIG. 5A is a sectional side elevation view of the one end portion of the pressure vessel illustrated in FIG. 5, takes along lines BB-BB in FIG. 5;

FIG. 5B is an enlarged view of Detail “D” in FIG. 5A;

FIG. 6 is a fragmentary, sectional side elevation view of a portion of an end cap of the pressure vessel illustrated in FIG. 2;

FIG. 7 is a fragmentary, sectional side elevation view of a portion of an end cap of the pressure vessel illustrated in FIG. 4;

FIGS. 8 to 12 illustrate manufacturing steps in the manufacture of an operative shell portion of an embodiment of a pressure vessel of a vehicular air brake system;

FIG. 13 is a table providing operating parameters related to the manufacturing operation illustrated in FIGS. 8 to 12, and

FIG. 14 is a sectional side elevation view of a fifth intermediate formed as a result of the manufacturing steps illustrated in FIGS. 8 to 12.

### DETAILED DESCRIPTION OF EMBODIMENTS OF THE INVENTION

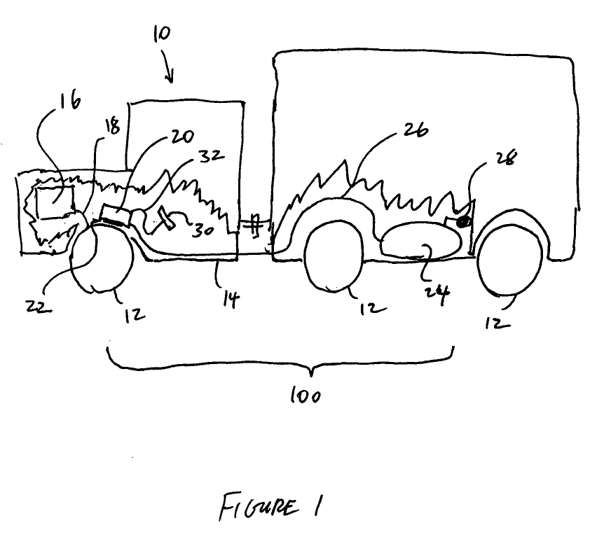

Referring to FIG. 1, there is provided a vehicular air brake system 100 for use with a vehicle 10 including a plurality of wheels 12 rotatably mounted to a vehicular frame 14. The vehicle 10 includes an engine 16, supported by the vehicular frame 14, and coupled to at least one of the wheels 12 with a transmission 18 so as to effect rotary movement of at least one of the wheels 12. Suitable vehicles 10 include automobiles and trucks. Each of the wheels 12 may be associated with an air brake apparatus 20. The vehicular air brake system 100 is used to effect the braking of one or more of the wheels 12. An example of the vehicular air brake system 100 will now be described with reference to its relationship with a single wheel 12 of a vehicle 10.

The vehicular air brake system 10 includes an air brake apparatus 20. The air brake apparatus 20 is configured for engaging a wheel 12 to effect braking of the wheel 12. A suitable air brake apparatus 20 is a drum brake. The air brake apparatus 20 is supported by the vehicular frame 14.

The air brake apparatus 20 includes a brake 22 for engaging the wheel 12 to effect braking of the wheel 12. The brake 22 is biased into engagement with the wheel 12 by, for example, a mechanical spring provided as part of the air brake apparatus 20.

The vehicular air brake system 100 includes a pressure vessel 24 configured for containing pressurized air. The pressure vessel 24 is supported by the vehicular frame 14. The pressure vessel 24 is fluidly coupled to the air brake apparatus 20 and is configured to supply pressurized air to the air brake apparatus 20 to overcome the biasing force being applied to the brake 22 (for example, by the above-described mechanical spring) and thereby effect disengagement of the brake 22 from the wheel 12. For example, the pressure vessel 24 supplies air through a conduit 26 to a diaphragm provided as part of the air brake apparatus 20. The conduit 26 includes a flexible hose. The diaphragm is coupled to the brake 22 and is configured to: (i) effect disengagement of the brake 22 from the wheel 12 when a pre-determined threshold force is applied by the pressurized air to the diaphragm, and/or (ii) to maintain the brake 22 in a condition of disengagement relative to the wheel 12 while a pre-determined threshold force is being applied by the pressurized air to the diaphragm.

The pressure vessel 24 is fluidly coupled to an air compressor 28. The air compressor 28 is supported on the vehicular frame 14 and is configured to supply compressed air to the pressure vessel 24 when air pressure within the pressure vessel 24 falls to a predetermined low level.

The brake 22 of the air brake apparatus 20 is actuated into a condition of engagement with the wheel 12 by a brake actuator 30, such as a foot pedal, which is supported by the vehicular frame 14. The brake actuator 30 is coupled to the air brake apparatus 20 and configured to apply a force to the air brake apparatus 20 to effect engagement of the brake 22 with the wheel 12. For example, the brake actuator 30 is fluidly coupled to the air brake apparatus 20 with brake actuator gas (through a conduit 32), such as air, to effect release of the pressurized air acting on the diaphragm in the air brake apparatus 20. An application of force to the brake actuator 30 effects pressurization of the brake actuator gas to create pressurized brake actuator gas. In turn, the pressurized brake actuator gas effects opening of a valve in the air brake apparatus 20 to release pressurized air acting on the diaphragm in the air brake apparatus 20, thereby causing a reduction of force being applied to the diaphragm by the pressurized air, which thereby effects engagement of the brake 22 to the wheel 12 once the force of the spring exceeds the force being applied to the diaphragm by the pressurized air.

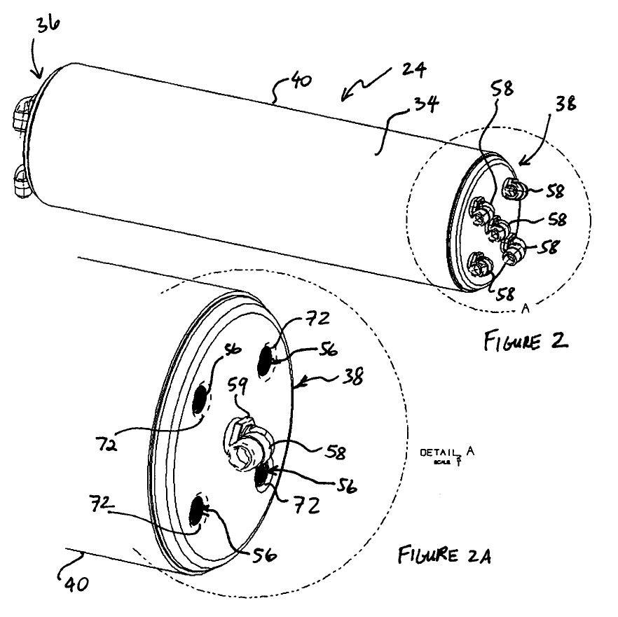

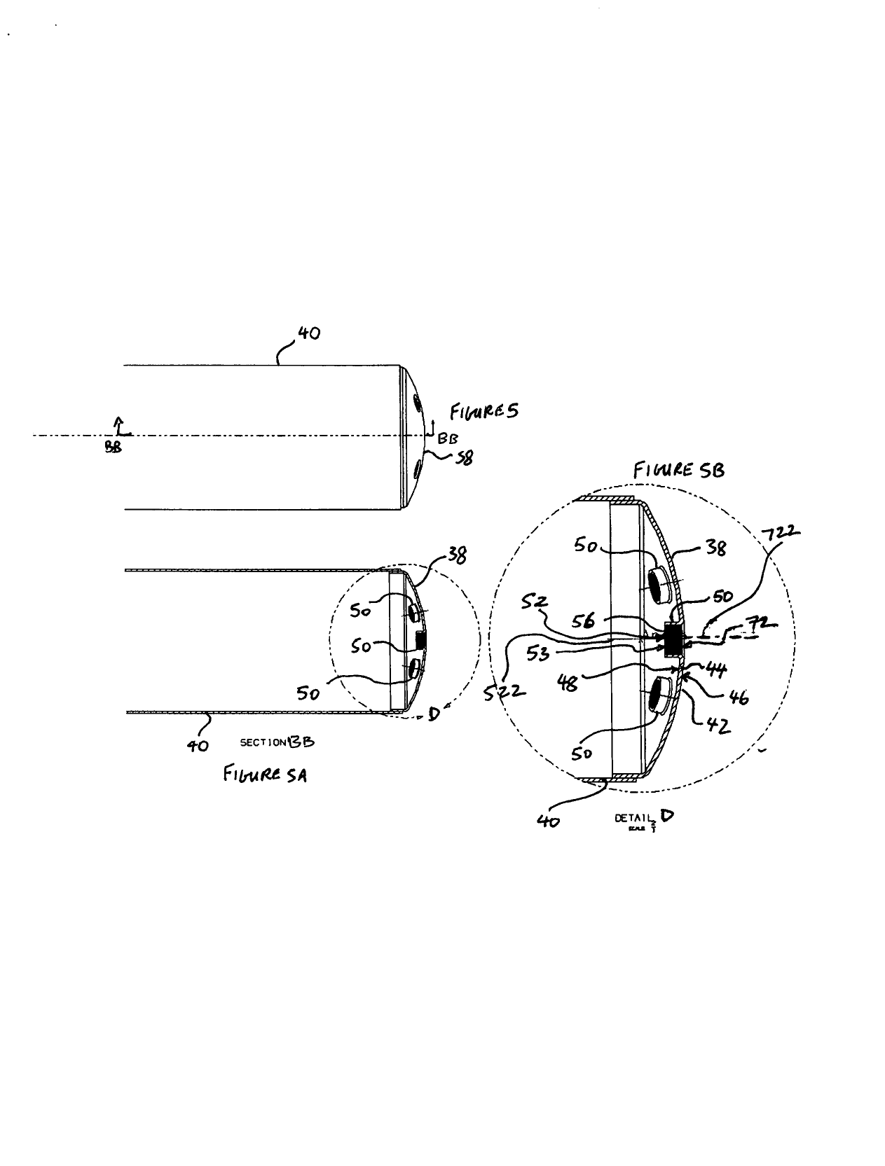

Referring to FIGS. 2, 2A, 3, 3A, 3B, 4, 4A, 5, 5A, and 5B, the pressure vessel 24 includes a shell 34. For example, the shell 34 includes steel, such as carbon steel. For example, the shell 34 includes first and second opposing end cap sections 36, 38 joined together by a substantially cylindrical shell section 40. For example, each of the end cap sections 36, 38 is welded to the substantially cylindrical shell section 40.

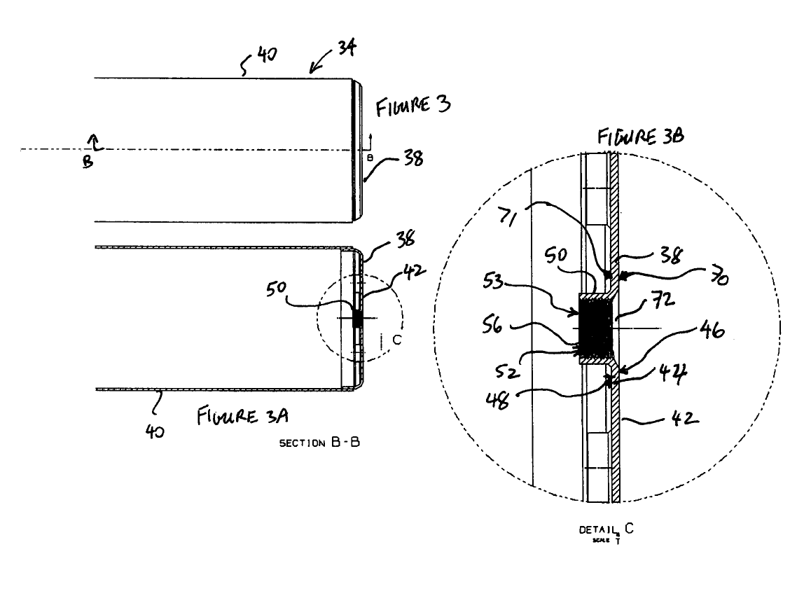

Referring to FIGS. 3, 3A, 3B, 5, 5A, 5B, 6, and 7, the shell 34 includes an operative shell portion 42. For example, the operative shell portion 42 includes steel, such as carbon steel. The operative shell portion 42 includes a vessel wall portion 44 including a first side surface 46 and an opposite second side surface 48.

Referring to FIGS. 3B, 5B, 6 and 7, a boss 50 is provided and protrudes or extends from one of the first and second side surfaces 46, 48 of the vessel wall portion 44. For example, in the illustrated embodiment, the boss 50 protrudes or extends internally within the pressure vessel 24 from the side surface 48 of the vessel wall portion 44 which is disposed internally within the pressure vessel 24, and is thereby configured for contacting by pressurized air when pressurized air is disposed within the pressure vessel 24.

The boss 50 also includes a boss threaded section 56 defined by straight pipe threads and configured for receiving a fitting 58 with a fitting threaded section 60 and a fitting fluid passage 62. The fitting threaded section 62 is configured to register with the boss threaded section 56 to effect coupling of the fitting 58 to the boss 50. For example, a locknut 59 is also provided to mitigate loosening of the fitting 58 from the boss 50.

The boss 50 includes a boss passage 53 which is fluidly coupled to an interior space 64 of the pressure vessel 24. The boss passage 53 is configured to effect fluid communication between the interior 64 of the pressure vessel 24 and the fitting fluid passage 62 when the fitting 58 is received within the boss threaded section 56 of the boss 50.

For example, the boss 50 includes a bore 52. The bore 52 includes the boss passage 53 and extends from a respective aperture 72 of the other one of the first and second side surface (e.g. side surface 46, as illustrated in the Figures). The bore 52 is defined by an internal sidewall portion 54, wherein the portion 54 includes a contoured section 55 which defines the boss threaded section 56. In this respect, the boss 50 is said to be internally threaded.

For example, with respect to the boss threaded section 56, the boss threaded section 56 is defined by straight pipe threads. For example, the boss threaded section 56 is defined by straight pipe threads in accordance with NPSL (American National Standard Straight Pipe Threads for Loose-fitting Mechanical Joints with Locknuts).

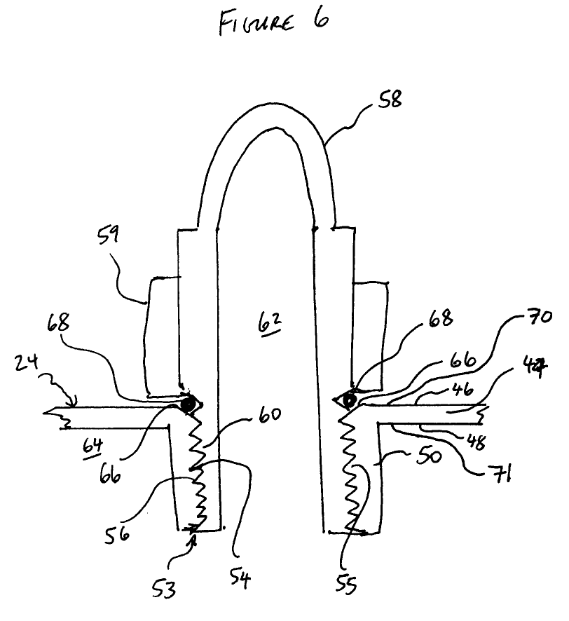

As more clearly illustrated in FIGS. 6 and 7, the boss 50 also includes a sealing surface 66 configured for receiving a sealing element 68, such as an o-ring. When the fitting 58 is coupled to the boss 50, the sealing element 68 is pressed between the fitting 58 and the sealing surface 66 to effect sealing or substantial sealing of the space between the boss 50 and the fitting 58.

Suitable fittings 58 for coupling to the boss 50 include any straight thread o-ring seal fitting, such as a check valve, a pressure relief valve, a manifold fitting, or an isolation valve.

For example, with respect to the vessel wall portion 44, the vessel wall portion 44 is at least a portion of either one of the end cap sections 36, 38. As a further example, each of the end cap sections 36, 38 includes a plurality of bosses 50, each of the bosses 50 extending or protruding from one of the first and second side surfaces 46, 48 of a respective vessel wall portion 44. As yet a further example, one of the end cap sections includes five (5) bosses and the other end cap section include five (5) bosses. However, it is understood that any number of bosses can be provided with either end cap section in order to effect the desired process connections.

Referring to FIGS. 3, 3A, 3B, 3C and 6, for example, with respect to the side surfaces 46, 48 of the vessel wall portion 44, each of the first and second side surfaces 46, 48 includes a respective substantially flat vessel wall side surface portion 70, 71. The portion 70 extends from the respective aperture 72 of the other one of the first and second side surfaces 46, 48 and is substantially co-planar with the plane in which the respective aperture 72 of the other one of the first and second side surfaces (in the illustrated embodiment, side surface 46) is disposed. For example, the substantially flat vessel wall portion 70 extends from the respective aperture 72, and also extends 360° about an axis 722 of the aperture 72. The portion 71 is that portion of the one of the first and second side surfaces 46, 48 (in the illustrated embodiment, side surface 48) from which the boss extends, and is disposed in a plane which is substantially parallel to the plane in which portion 70 is disposed. In this respect, the portion 71 extends from the boss 50, and also extend 360° about an axis 522 of the bore 52 of the boss 50.

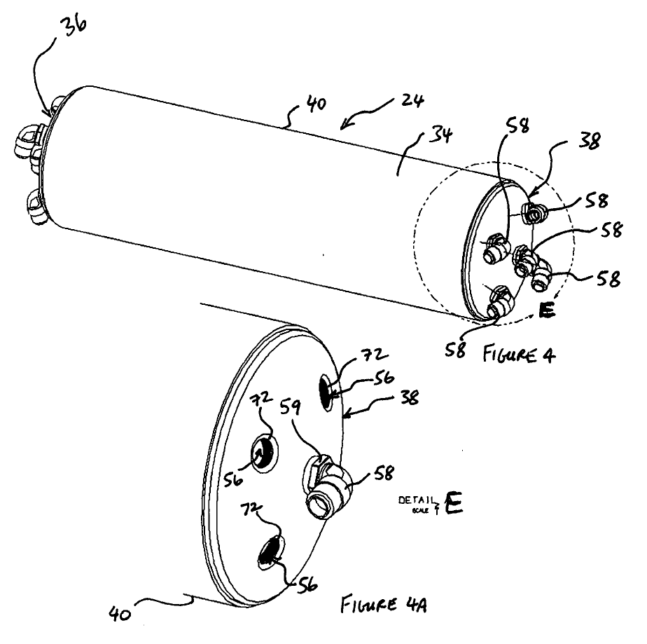

Referring to FIGS. 4, 4A, 5, 5A, 5B, and 7, the first and second side surfaces 46, 48 must not necessary include a substantially flat portion. For example, in the embodiment illustrated in FIGS. 4, 4A, 5, 5A, 5B, and 7, the side surfaces 46, 48 are dome-shaped.

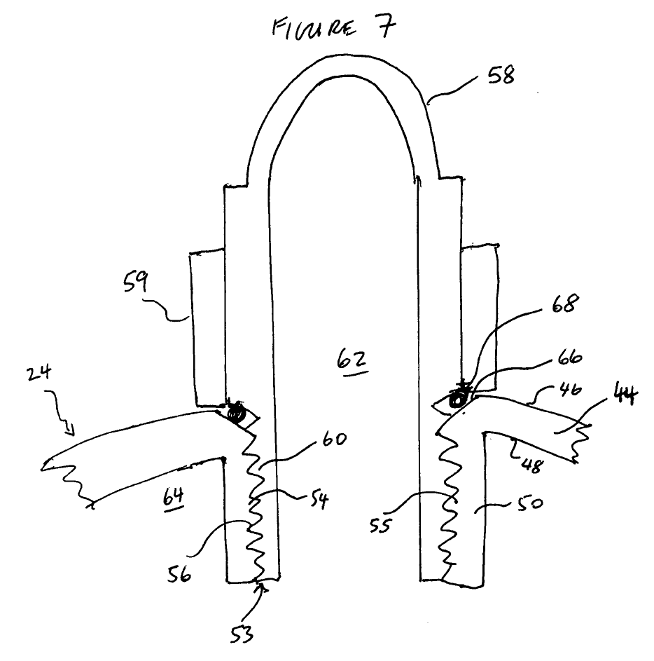

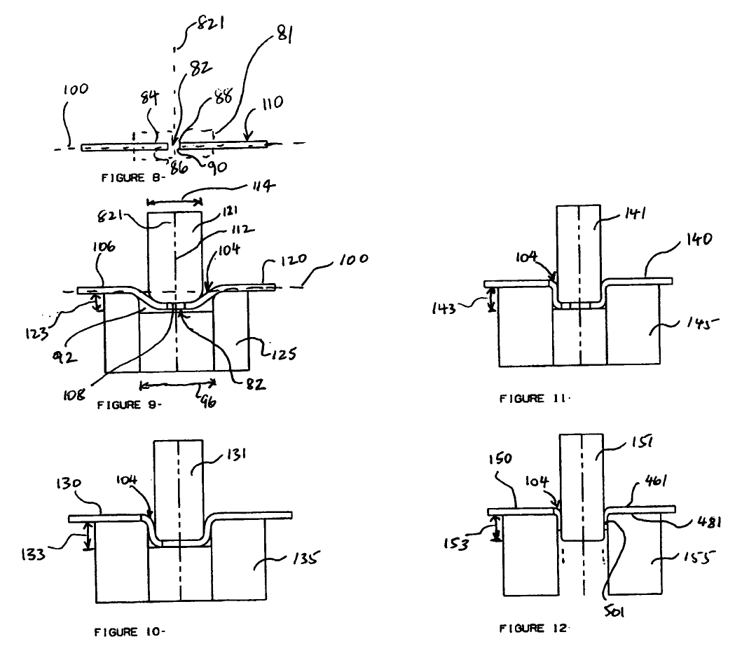

For example, with respect to the manufacturing of the operative shell portion, the operative shell portion 42, having the boss 50, is manufactured from a steel blank, using a metal forming method. An example of a metal forming method for manufacturing the operative shell portion, 42 having the boss 50, is now described below, with reference to FIGS. 8 to 12.

Step 1: A substantially flat blank, in the form of a 0.122 inches carbon steel plate, is provided and has an axis disposed in an operative plane 100. The blank is subjected to a piercing operation to produce a first intermediate 110 having a substantially centrally disposed bore 82 extending from one side 84 of the first intermediate 110 to the opposite side 86 of the first intermediate 110 (see FIG. 8). The bore 82 couples respective apertures 88, 90 on both sides of the first intermediate 110. For example, the bore 82 has a substantially constant, circular cross-section along its length, and has a diameter of 6 millimetres.

Step 2: Referring to FIGS. 8 and 9, an operative portion 81 of the first intermediate 110, extending radially from the bore 82 and 360° about the axis 821 of the bore 82, is then drawn into a cavity 92 of a first die 125 (hereinafter, “the first drawing operation”), characterized by a first die diameter 96, to a first intermediate depth 123 and in a direction normal to the operative plane 100, to thereby produce a second intermediate 120. The second intermediate 120 includes an operative second intermediate portion 104 with a disc-shaped contour with arcuate sidewalls extending inwardly from a substantially flat surface portion disposed in the operative plane, and thereby defines a corresponding disc-shaped cavity. The substantially flat surface portion 106 is that part of the blank whose shape remains substantially unaffected by the drawing operation. The drawing operation is effected by pressing a contact surface 108 of a first draw punch 121 against the first intermediate operative portion 81, in a direction normal to the operative plane. The longitudinal axis 112 of the first draw punch 121 is in alignment with the axis 821 of the bore 82 while the contact surface 108 is being pressed against the first intermediate operative portion 81. The contact surface 108 of the first draw punch 121 is characterized by an arcuate-shaped surface having a first draw diameter 114.

Step 3: The second intermediate 120 is then subjected to a further three successive drawing operations (i.e. the second, third, and fourth drawing operations, which are illustrated in FIGS. 10, 11, and 12, respectively), forming third, fourth, and fifth intermediates 130, 140, 150, and causing the sidewalls defined by the operative second intermediate portion 104 to progressively assume an increasingly flattened contour characterized by an inwardly facing surface which progressively approaches a substantially planar surface whose normal axis is substantially orthogonal to the normal axis of the operative plane. Each of the three successive drawing operations is similar, with changes to the following parameters: the configuration of the die, the configuration of the draw punch, and the depth to which the progressively-worked on blank is drawn by the draw punch. In this respect, with each of the first, second, third, and fourth drawing operations, there is associated: (i) a corresponding first, second, third, and fourth die 125, 135, 145, and 155, (ii) a corresponding first, second, third, and fourth draw punch 121, 131, 141, and 151; and (iii) a corresponding first, second, third, and fourth depths 123, 133, 143, and 153 to which the progressively-worked on blank is drawn by the corresponding draw punch. With respect to the first, second, third, and fourth dies, each of these dies is characterized by a respective die cavity having a respective die cavity diameter different than that of the other respective dies. With respect to the first, second, third, and fourth draw punches 125, 135, 145, and 155, each of these draw punches is characterized by a respective contact surface having a respective draw punch diameter.

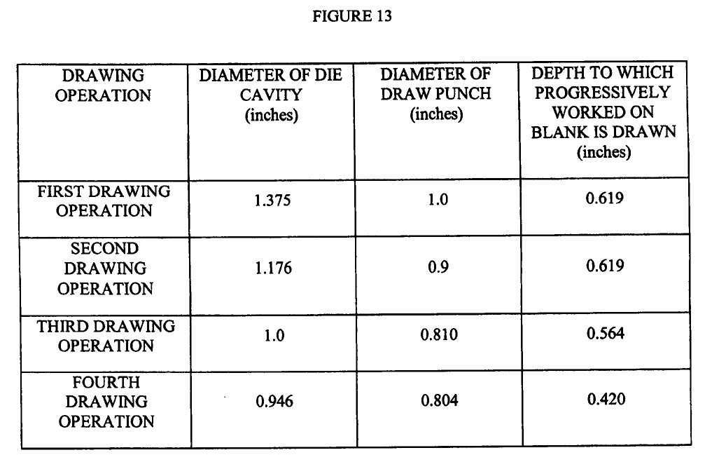

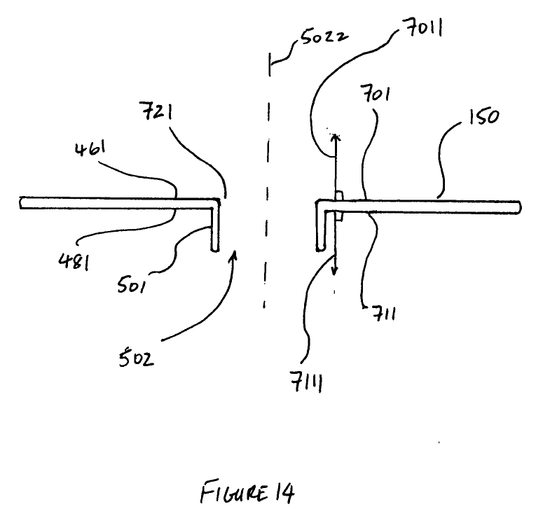

An example of the above-described die cavity diameter, draw punch diameter, and depth parameters, for each of the first, second, third, and fourth drawing operations, of a metal forming method for making the operative shell portion 42 having the aforementioned boss 50, is in FIG. 13. Notably, for each successive drawing operation, the respective die cavity diameter of the corresponding die becomes successively smaller. Also, for each successive drawing operation, the respective draw punch diameter of the corresponding draw punch becomes progressively smaller. With respect to the depths to which the progressively-worked on blank is drawn by the corresponding draw punch in the second, third and fourth drawing operations, as the sidewalls defined by the operative second intermediate portion progressively assume the increasingly flattened contour described above, the depths to which the progressively-worked on blank is drawn by the draw punch becomes progressively smaller from the second to the third drawing operations and then from the third to the fourth drawing operations.

Referring to FIG. 14, upon completion of the fourth drawing operation, there is provided a fifth intermediate 150 including an intermediate first side surface 461 and an opposite intermediate second side surface 481. The fifth intermediate 150 also includes an intermediate boss 501 extending from one of the side surfaces 461, 481 (in this case, surface 481) having a bore 502 extending from a respective aperture 721 of the other one of the side surfaces 461, 481 (in this case, surface 461). The intermediate bore 502 of the boss 501 is characterized by an axis 5022.

Step 4: The fifth intermediate is then subjected to a tapping operation to effect creation of a straight pipe thread within the intermediate bore 502 and, more particularly, on the internal sidewall portion 54 defining the intermediate bore 502 to thereby form the threaded bore 52.

At the end of these steps, there is provided the operative shell portion 42 having the internally threaded boss 50, wherein the threads are of the straight pipe thread-type. An operative shell portion 42 having a plurality of bosses 50 could be manufactured in analogous manner, from this same blank. For example, the manufacture of an operative shell portion 42 including one or more bosses 50 can be effected using a progressive die-type punch transfer assembly.

The worked-upon blank may be further worked-upon and coupled with other shell portions to create a pressure vessel 24. For example, the blank may be subjected to further metal-forming operations along its perimeter to produce a bend at the perimeter, and thereby create an end cap. A second, similar end cap could also be created in accordance with the above-described method. The two end caps are then welded to a respective one of each end of a substantially cylindrical shell portion to create a pressure vessel.

For example, with respect to the fifth intermediate, and more particularly with respect to the side surfaces 461, 481, each of the side surfaces 461, 481 of the fifth intermediate includes a respective substantially flat intermediate side surface portion 701, 711. In the illustrated example, side surface portion 701 of side surface 461 extends from the respective aperture 721 and also extends 360° about an axis of the aperture 721. The side surface portion 711 is that portion of the side surface 481 from which the intermediate boss 501 extends. In this respect, the side surface portion 711 extends from the intermediate boss 501 and also extends 360° about an axis of the intermediate bore 502 of the boss 501. The portion 701 is disposed in a plane substantially parallel to the plane within which the portion 711 is disposed. Each of the portions 701, 711 has a respective normal axis 7011, 7111, and the axis 5022 is substantially parallel to each of the axes 7011, 7111. The portion 701 defines the portion 70 of the other one of the first and second side surfaces 46, 48 of the vessel wall portion 44 of the operative shell portion 42 of the shell 34 of the pressure vessel 24, and the portion 711 defines the portion 71 of the one of the first and second surfaces 46, 48 of the vessel wall portion 44 of the operative shell portion 42 of the shell of the pressure vessel 24. For example, with respect to the portions 701, 711, each of these portions 701, 711 is characterized by a surface configured to substantially eliminate the risk of failure of a tap or tapping equipment when the thread of the bore 50 is being formed by the tap and the tapping equipment during the tapping operation. For example, each of the portions 701, 703 is characterized by a minimum width of at least 0.5 inches.

As a further example, with respect to the manufacturing of the operative shell portion 42, the boss 50 is extruded from a steel blank used to manufacture the operative shell portion 42. In this respect, the boss 50 is said to be an extrusion.

It will be understood, of course, that modifications can be made in the embodiments of the invention described herein without departing from the scope and purview of the invention as defined by the appended claims.

What is claimed is:

1. A pressure vessel for defining a pressure boundary between a higher pressure side and a lower pressure side, wherein the pressure vessel includes a first shell portion comprising:
a vessel wall portion; and
a boss protruding from the vessel wall portion;
wherein the boss includes a boss threaded section defined by straight pipe threads for receiving a fitting with a fitting threaded section, and wherein the fitting threaded section is configured to register with the boss threaded section.

2. The pressure vessel as claimed in claim 1, wherein the boss is formed from a blank used to manufacture the first shell portion.

3. The pressure vessel as claimed in claim 1, wherein the boss is an extrusion from a blank used to manufacture the first shell portion.

4. The pressure vessel as claimed in claim 1, wherein the boss includes a fluid passage configured to effect fluid communication between an interior of the pressure vessel and the fitting received within the boss.

5. The pressure vessel as claimed in claim 4, wherein the boss includes a bore which is fluidly coupled to the fluid passage, and wherein the bore includes a internal surface which defines the boss threaded section.

6. The pressure vessel as claimed in claim 1, wherein the boss protrudes into the interior of the pressure vessel.

7. The pressure vessel as claimed in claim 1, wherein the pressure vessel further includes a second shell portion coupled to the first shell portion.

8. The pressure vessel as claimed in claim 1, wherein a sealing element is provided between the boss and the fitting to effect sealing of the space between the boss and the fitting.

9. A pressure vessel for defining a pressure boundary between a higher pressure side and a lower pressure side, wherein the pressure vessel includes a first shell portion comprising:
a vessel wall portion including a first side surface and an opposite second side surface; and
a boss protruding from one of the first and second side surfaces, wherein the boss includes a bore including a boss threaded section for receiving a fitting with a fitting threaded section configured to register with the boss threaded section, and wherein the boss is configured to effect fluid communication between an interior of the pressure vessel and the fitting when the fitting is received within the boss;
wherein the other one of the first and second side surfaces includes a first substantially flat portion extending from a respective aperture of the other one of the first and second side surfaces and substantially within a plane having a normal axis which is substantially parallel to the axis of the respective aperture of the other one of the first and second side surfaces and 360° about an axis of the respective aperture;
and wherein the one of the first and second side surfaces includes a second substantially flat portion extending from the boss and also extending 360° about the bore of the boss and disposed in a plane which is parallel to the plane within which the other one of the first and second side surfaces is disposed.

10. The pressure vessel as claimed in claim 9, wherein the boss is formed from a blank used to manufacture the first shell portion.

11. The pressure vessel as claimed in claim 9, wherein the boss is an extrusion from a blank used to manufacture the first shell portion.

12. The pressure vessel as claimed in claim 9 wherein the boss threaded section is defined by straight pipe threads.

13. The pressure vessel as claimed in claim 9, the boss includes a fluid passage to effect fluid communication between an interior of the pressure vessel and the fitting when the fitting is received within the boss, and wherein the boss also includes a bore which extends from the respective aperture of the other one of the first and second side surfaces, and wherein the bore includes a internal surface which defines the boss threaded section.

14. The pressure vessel as claimed in claim 9, wherein the boss protrudes into the interior of the pressure vessel.

15. The pressure vessel as claimed in claim 9, wherein the pressure vessel further includes a second shell portion coupled to the first shell portion.

16. The pressure vessel as claimed in claim 9, wherein a sealing element is provided between the boss and the fitting to effect sealing of the space between the boss and the fitting.

17. The pressure vessel as claimed in claim 9, wherein the one of the first and second side surfaces, from which the boss protrudes, is provided on the high pressure side of the pressure boundary.

18. The pressure vessel as described in claim 9, wherein each of the first and second substantially flat portions includes a minimum width of at least 0.5 inches.

19. A vehicular air brake system, comprising:
a vehicle;
a wheel rotatably coupled to the vehicle;
an air brake configured for engaging the wheel to effect braking of the wheel;
a pressure vessel configured for containing pressurized air, wherein the pressure vessel is fluidly coupled to the air brake and is configured to supply pressurized air to the air brake to bias the air brake to a position wherein the air brake is disengaged from the wheel; and
a brake actuator coupled to the brake and configured to apply a force to the air brake to effect engagement of the air brake to the wheel in response to an application of force to the brake actuator;
wherein the pressure vessel includes a first shell portion comprising:
a vessel wall portion; and
a boss protruding from the vessel wall portion;
and wherein the boss includes a boss threaded section defined by straight pipe threads for receiving a fitting with a fitting threaded section, and wherein the fitting threaded section is configured to register with the boss threaded section.

20. The vehicular air brake system as claimed in claim 19, wherein the boss is formed from a blank used to manufacture the first shell portion.

21. The vehicular air brake system as claimed in claim 19, wherein the boss is an extrusion from a blank used to manufacture the first shell portion.

22. The vehicular air brake system as claimed in claim 19, wherein the boss includes a fluid passage configured to effect fluid communication between an interior of the pressure vessel and the fitting received within the boss.

23. The vehicular air brake system as claimed in claim 22, wherein the boss includes a bore which is fluidly coupled to the fluid passage, and wherein the bore includes a internal surface which defines the boss threaded section.

24. The vehicular air brake system as claimed in claim 19, wherein the boss protrudes into the interior of the pressure vessel.

25. The vehicular air brake system as claimed in claim 19, wherein the pressure vessel further includes a second shell portion coupled to the first shell portion.

26. The vehicular air brake system as claimed in claim 19, wherein a sealing element is provided between the boss and the fitting to effect sealing of the space between the boss and the fitting.

27. A vehicular air brake system, comprising:
a vehicle;
a wheel rotatably coupled to the vehicle;
an air brake configured for engaging the wheel to effect braking of the wheel;
a pressure vessel configured for containing pressurized air, wherein the pressure vessel is fluidly coupled to the air brake and is configured to supply pressurized air to the air brake to bias the air brake to a position wherein the air brake is disengaged from the wheel; and
a brake actuator coupled to the brake and configured to apply a force to the air brake to effect engagement of the air brake to the wheel in response to an application of force to the brake actuator;
wherein the pressure vessel includes a first shell portion comprising:
a vessel wall portion including a first side surface and an opposite second side surface; and
a boss protruding from one of the first and second side surfaces, wherein the boss includes a boss threaded section for receiving a fitting with a fitting threaded section configured to register with the boss threaded section, and wherein the boss includes a fluid passage configured to effect fluid communication between an interior of the pressure vessel and the fitting received within the boss;
wherein the other one of the first and second side surfaces includes a first substantially flat portion extending from the respective aperture of the other one of the first and second side surfaces and substantially within a plane having a normal axis which is substantially parallel to the axis of the respective aperture of the other one of the first and second side surfaces and also extending 360° about an axis of the respective aperture;
and wherein the one of the first and second side surfaces includes a second substantially flat portion extending from the boss and also extending 360° about the bore of the boss and disposed in a plane which is parallel to the plane within which the other one of the first and second side surfaces is disposed.

28. The vehicular air brake system as claimed in claim 27, wherein the boss is formed from a blank used to manufacture the first shell portion.

29. The vehicular air brake system as claimed in claim 27, wherein the boss is an extrusion from a blank used to manufacture the first shell portion.

30. The vehicular air brake system as claimed in claim 27 wherein the boss threaded section is defined by straight pipe threads.

31. The vehicular air brake system as claimed in claim 27 wherein the boss includes a fluid passage to effect fluid communication between an interior of the pressure vessel and the fitting when the fitting is received within the boss, and wherein the boss also includes a bore which extends from the respective aperture of the other one of the first and second side surfaces, and wherein the bore includes a internal surface which defines the boss threaded section.

32. The vehicular air brake system as claimed in claim 27, wherein the boss protrudes into the interior of the pressure vessel.

33. The vehicular air brake system as claimed in claim 27, wherein the pressure vessel further includes a second shell portion coupled to the first shell portion.

34. The vehicular air brake system as claimed in claim 27, wherein a sealing element is provided between the boss and the fitting to effect sealing of the space between the boss and the fitting.

35. The vehicular air brake system as claimed in claim 27, wherein the one of the first and second side surfaces, from which the boss protrudes, is provided on the high pressure side of the pressure boundary.

36. The pressure vessel as described in claim 27, wherein each of the first and second substantially flat portions includes a minimum width of at least 0.5 inches.

37. A vehicular air brake system, comprising:
a vehicle;
a wheel rotatably coupled to the vehicle;
an air brake configured for engaging the wheel to effect braking of the wheel;
a pressure vessel configured for containing pressurized air, wherein the pressure vessel is fluidly coupled to the air brake and is configured to supply pressurized air to the air brake to bias the air brake to a position wherein the air brake is disengaged from the wheel; and
a brake actuator coupled to the brake and configured to apply a force to the air brake to effect engagement of the air brake to the wheel in response to an application of force to the brake actuator;
wherein the pressure vessel includes a first shell portion comprising:
a vessel wall portion; and
a boss protruding from the vessel wall portion;
wherein the boss includes a boss threaded section for receiving a fitting with a fitting threaded section, and wherein the fitting threaded section is configured to register with the boss threaded section, and wherein the boss is formed from a blank used to manufacture the first shell portion.

38. The vehicular air brake system as claimed in claim 37, wherein the boss is an extrusion from a blank used to manufacture the first shell portion.

39. The vehicular air brake system as claimed in claim 37, wherein the boss includes a fluid passage configured to effect fluid communication between an interior of the pressure vessel and the fitting received within the boss.

40. The vehicular air brake system as claimed in claim 39, wherein the boss includes a bore which is fluidly coupled to the fluid passage, and wherein the bore includes a internal surface which defines the boss threaded section.

41. The vehicular air brake system as claimed in claim 37, wherein the boss protrudes into the interior of the pressure vessel.

42. The vehicular air brake system as claimed in claim 37, wherein the pressure vessel further includes a second shell portion coupled to the first shell portion.

43. The vehicular air brake system as claimed in claim 37, wherein a sealing element is provided between the boss and the fitting to effect sealing of the space between the boss and the fitting.
